(19) United States
(12) Patent Application Publication
(10) Pub. No.: US 2021/0212291 A1
(43) Pub. Date: Jul. 15, 2021

(54) NOVEL NON-SLIP ADJUSTABLE MULTIFUNCTIONAL PET TRACTION ROPE

(71) Applicants: Youchao Su, Shangrao City (CN); Xiaojia Su, Shangrao City (CN)

(72) Inventors: Youchao Su, Shangrao City (CN); Xiaojia Su, Shangrao City (CN)

(21) Appl. No.: 16/740,506

(22) Filed: Jan. 13, 2020

(51) Int. Cl. A01K 27/00; D03D 1/00; A01K 1/06; B60R 22/10; A44B 11/25; A44B 11/26

(52) U.S. Cl. CPC A01K 27/003; D03D 1/00; A01K 1/06; A44B 11/266; A01K 27/008; A01K 27/006; A44B 11/2503; B60R 22/10

(57) ABSTRACT

A novel non-slip adjustable multifunctional pet traction rope, including a first webbing, a parachute cord woven handle, a first webbing elastic part, a second webbing, and a pulling handle. A movable ring snap hook, a first D-ring and the parachute rope woven handle are fixedly sewn on the first webbing in sequence. The other end of the first webbing is fixedly sewn with one end of the first webbing elastic part, and the other end of the first webbing elastic part is fixedly sewn with a male buckle. The first webbing is connected to the second webbing. The first webbing is movable sleeved with a fixing square buckle, and the second webbing is movable sleeved with an adjustable hook, an insertion buckle and a second D-ring. The pets can be controlled fixed at waist, arm or other objects to realize a quick fixing and release.

### TECHNICAL FIELD

The present disclosure relates to a pet traction rope, in particular to a novel non-slip adjustable multifunctional pet traction rope.

### BACKGROUND

The existing dog traction rope products have single or incomplete functions, and many have only basic functions. Most of the handles used by the existing dog traction rope products are fixed and cannot be adjusted, resulting in limited use. Many dog traction rope products with a fixed waist function often have a separate belt, which is cumbersome to use, bulky and unportable, and consumes a lot of materials.

### SUMMARY

In order to overcome the defects of the prior art, a novel non-slip adjustable multifunctional pet traction rope is provided by the present disclosure. The handle part can realize functions such as quick release and wide-range adjustment, so that the dogs can be controlled fixed at tree, guardrail, handle, street light pole, telegraph pole, waist, arm or other objects, and it is convenient to adjust and use.

For solving the above technical problems, the technical solution of the present disclosure is provided as follows: A novel non-slip adjustable multifunctional pet traction rope, including a movable ring snap hook, a first webbing, a parachute rope woven handle, a first webbing elastic part, and a second webbing and a pulling handle. Wherein the movable ring snap hook, a first D-ring and the parachute rope woven handle are fixedly sewn on the first webbing in sequence, the other end of the first webbing is fixedly sewn with one end of the first webbing elastic part, the other end of the first webbing elastic part is fixedly sewn with a male buckle of automobile safety buckle that can be connected with a female buckle of automobile safety buckle for fixing, and the other end of the first webbing elastic part is connected to one end of the second webbing through a square ring. The first webbing elastic part is movable sleeved with a fixing square buckle, the second webbing is movable sleeved with an adjustable hook, an insertion buckle and a second D-ring. The insertion buckle is composed of a male buckle and a female buckle, one of the male buckle and the female buckle is sleeved on the second webbing, the other is fixedly sewn at one end of the second webbing, and the male buckle and the female buckle of the insertion buckle are fixedly buckled, so that one end of the second webbing forms a pulling handle. The second D-ring is located between the male buckle and the female buckle of the insertion buckle, that is, located on the pulling handle, and the adjustable hook is located outside the male buckle and the female buckle of the insertion buckle.

As a preferred technical solution of the present disclosure, the first webbing is a reflective webbing, and the first webbing elastic part is a reflective elastic webbing, the second webbing is a rubber-coated webbing, and reflective patterns are printed on both sides of the second webbing.

As a preferred technical solution of the present disclosure, a dog poop bag can be carried on the first D-ring or the second D-ring. The first D-ring and the second D-ring may be made of metal material, or is an elastic D-ring made of elastic rubber/silicone/latex.

As a preferred technical solution of the present disclosure, the insertion buckle is a common buckle or an illuminated buckle.

As a preferred technical solution of the present disclosure, the pulling handle is provided with a waist bag or an accessory bag.

As a preferred technical solution of the present disclosure, the parachute rope woven handle is configured to use as a handle when the pulling handle is configured to use as a collar after being adjusted by the insertion buckle, and the parachute rope woven handle is able to store with accessories. After the forward and backward transposition, it can still be used with the dog poop bag to realize the basic functions of pet traction rope and collar.

As a preferred technical solution of the present disclosure, the pulling handle can realize quick release and wide-range adjustment functions after being adjusted by the insertion buckle, and the pets can be controlled fixed at tree, guardrail, handle, street light pole, telegraph pole, waist, arm or other objects to realize a quick fixing and quick release.

As a preferred technical solution of the present disclosure, the fixing square buckle slides back and forth on the first webbing elastic part to realize the fixing and storage of the male buckle of automobile safety buckle, the male buckle of automobile safety buckle can be inserted into the female buckle of automobile safety buckle to achieve mounting a pet in car.

As a preferred technical solution of the present disclosure, the first webbing or the first webbing elastic part or the second webbing has a stitching position as square or rectangular diagonal cross stitching, plus M/W continuous cross stitching, to ensure solid and reliable use.

As a preferred technical solution of the present disclosure, the second webbing passes through the adjustable hook and the insertion buckle in an M shape to achieve fixing half portion of the insertion buckle (male buckle or female buckle), so as to quickly realize a series of operating steps such as non-slip, quick release, arbitrary range adjustment and fixing, and the other half of the insertion buckle is enclosed to form a fixed second webbing loop, a size of the second webbing loop is limited by a length of the webbing, and the size of the second webbing loop is freely adjusted on the second webbing with a fixed length.

Compared with the prior art, the advantageous effects that the present disclosure can achieve are as following:

The present disclosure uses the fixing square buckle to slide back and forth on the webbing to realize the fixing and storage of the automobile safety buckle. The male buckle of automobile safety buckle can be inserted into the female buckle of automobile safety buckle to realize mounting the dog in car. The reflective pattern is painted on both sides of the rubber-coated webbing to achieve a reflective effect. The second webbing is M-shaped inserted with the the insertion buckle and the adjustable hook to achieve fixing half portion of the insertion buckle (male buckle or female buckle), so as to quickly realize a series of operating steps such as non-slip, quick release, arbitrary range adjustment and fixing, and the other half of the insertion buckle is enclosed to form a fixed second webbing loop, the size of the second webbing loop is limited by a length of the webbing, and the size of the second webbing loop is freely adjusted on the second webbing with a fixed length. The D-ring can be made of rubber (silicone/latex/rubber) elastic material and can be installed and removed through the insertion buckle. The pulling handle can be adjusted to correspond to the size of the pet's neck and used as a collar to protect the pet's neck and the parachute rope woven handle can be used as a handle at this time. The parachute rope woven handle can be stored with accessories. The parachute rope woven handle can increase friction and non-slip, and it can still be used with dog poop bag to realize the basic functions of pet traction rope and collar after the forward and backward transposition. The stitching position as square or rectangular diagonal cross stitching, plus M/W continuous cross stitching, to ensure solid and reliable use.

### BRIEF DESCRIPTION OF THE DRAWINGS

FIG. 1 is a schematic structural view showing a front of a product of the present disclosure;

FIG. 2 is a schematic structural view showing a reverse of the product of the present disclosure;

FIG. 3 is a schematic structural view showing a right side of the product of the present disclosure;

FIG. 4 is a schematic structural view showing a left side of the product of the present disclosure;

FIG. 5 is a first partial view showing details of the product of the present disclosure;

FIG. 6 is a second partial view showing details of the product of the present disclosure;

FIG. 7 is a view showing a use state when the present disclosure is fixed on a street light pole or a telephone pole;

FIG. 8 is a view showing a use state when the present disclosure is fixed on a guardrail;

FIG. 9 is a view showing a use state when the present disclosure is fixed on a tree;

FIG. 10 is a view showing a use state when the present disclosure is fixed on a human arm;

FIG. 11 is a view showing a use state when the present disclosure is fixed on a human waist;

FIG. 12 is a view showing a use state that the dog poop bag is used in a forward position when the present disclosure is in forward use;

FIG. 13 is a view showing a use state that the dog poop bag is used in a backward position when the present disclosure is in forward use;

FIG. 14 is a view showing the present disclosure in backward use;

FIG. 15 is a view showing a usage scenario of a car seat of the present disclosure.

In Figures: 1. movable ring snap hook; 2. first D-ring; 3. first webbing, 4. parachute rope woven handle; 5. first webbing elastic part; 6. fixing square buckle; 7. male buckle of automobile safety buckle; 8. square ring; 9. second webbing; 10. reflective pattern; 11. adjustable hook; 12. insertion buckle; 13. second D-ring; 14. pulling handle; 15. dog poop bag; 18. female buckle of automobile safety buckle; 20. waist bag/accessory bag.

### DETAILED DESCRIPTION OF THE EMBODIMENTS

The preferred embodiments of the present disclosure will be further described and illustrated with the accompanying drawings as below, and it should be understood that the preferred embodiments described herein are only used to illustrate and explain the present disclosure, not intended to limit the present disclosure.

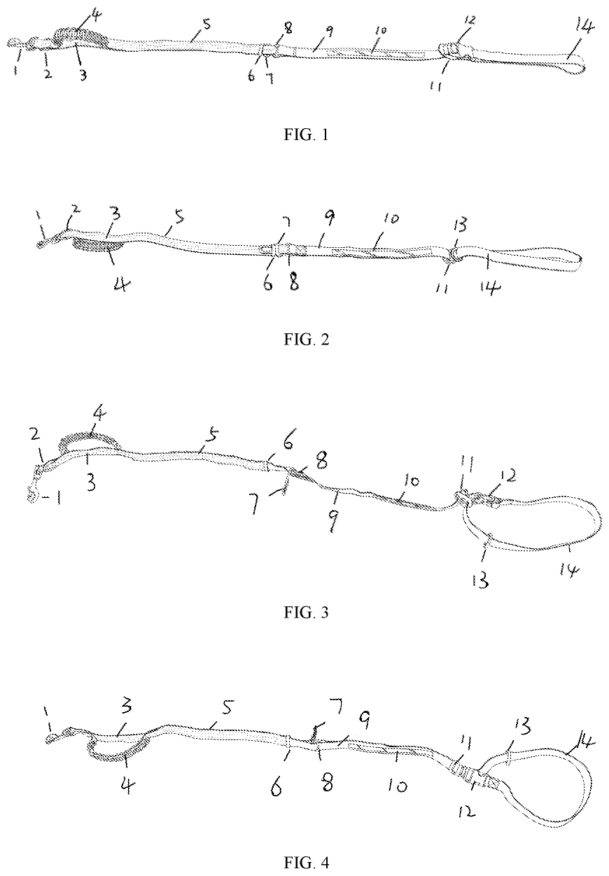

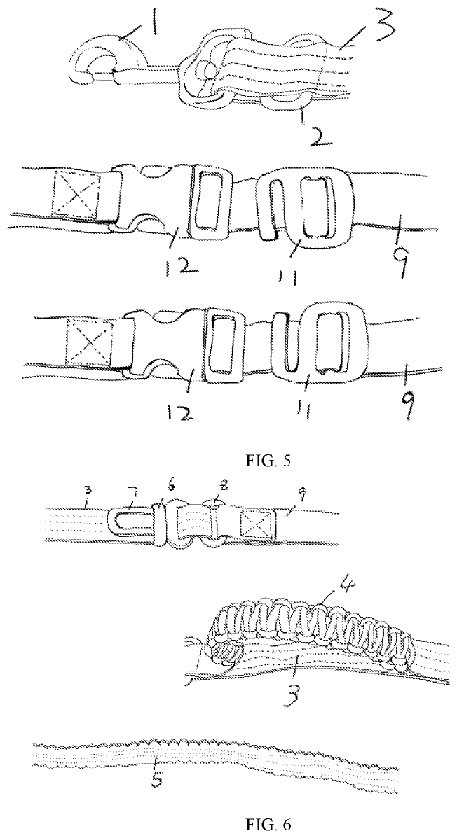

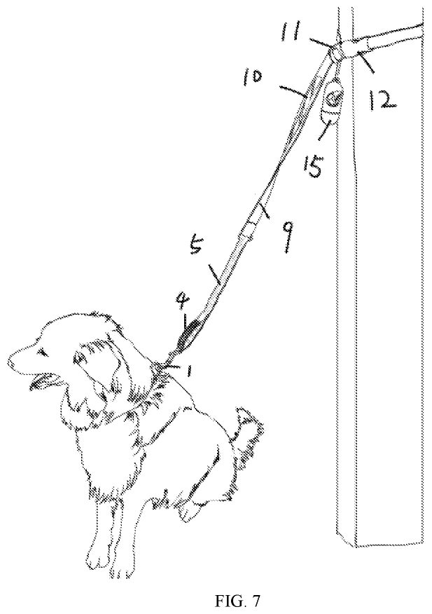

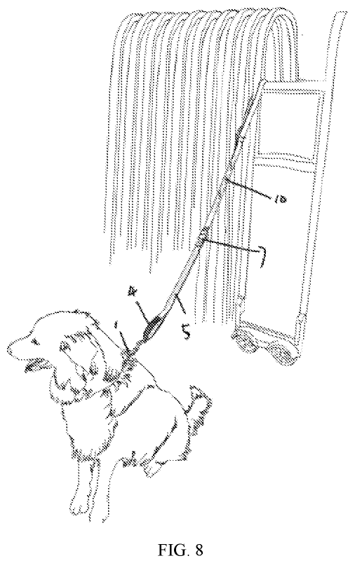

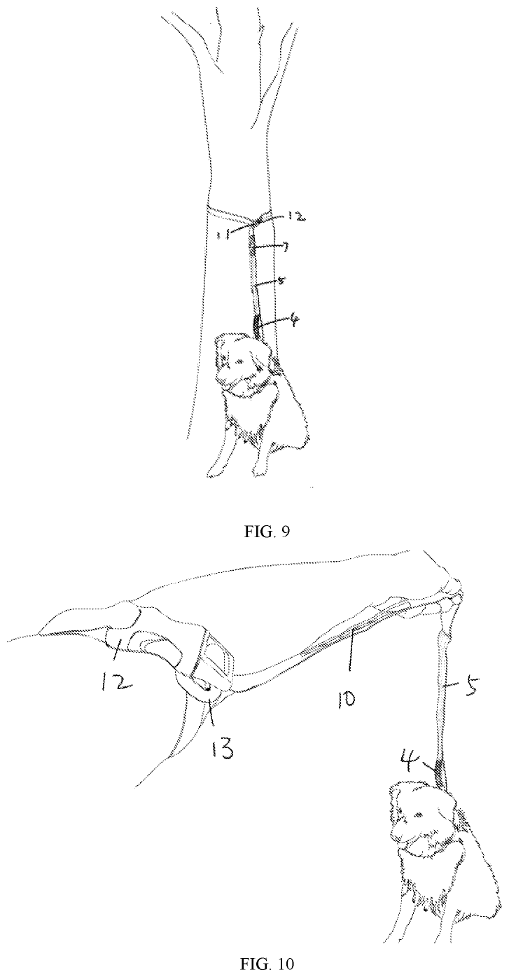

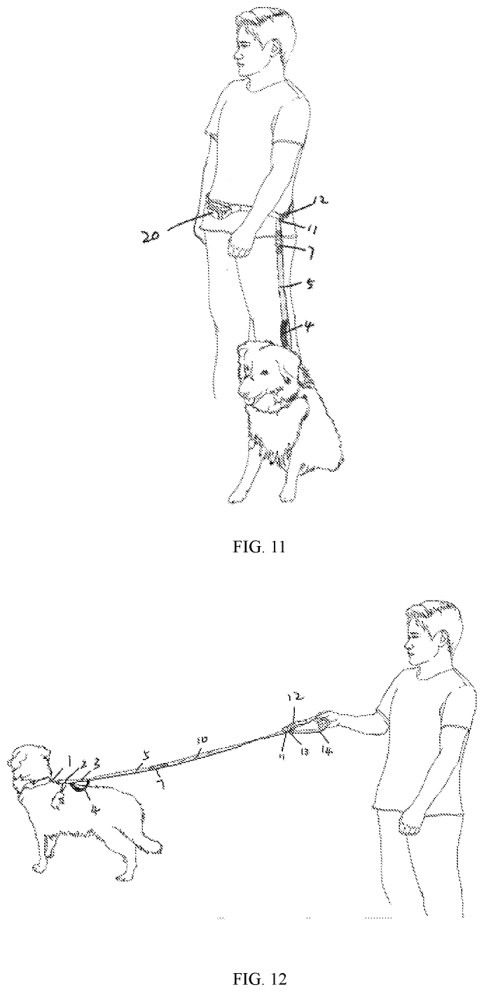

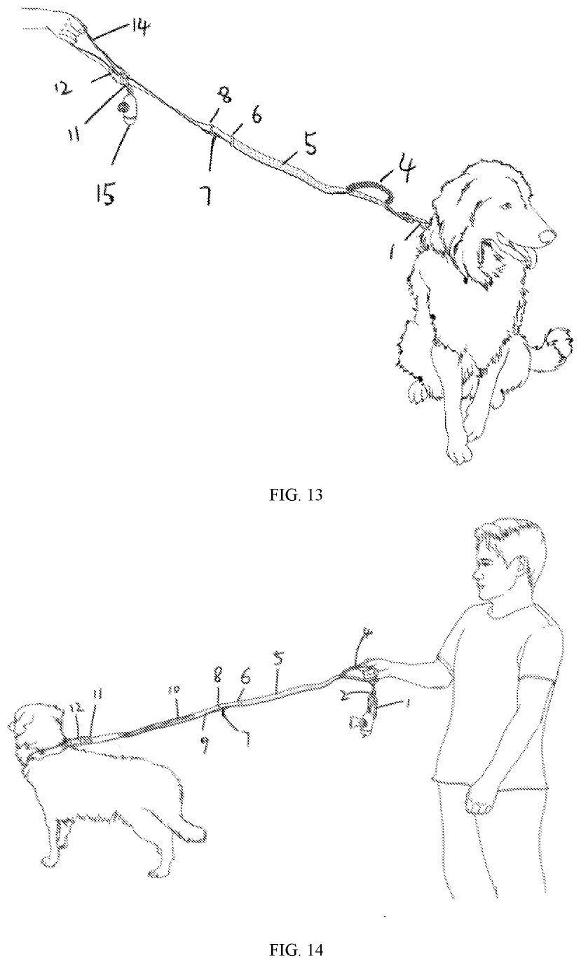

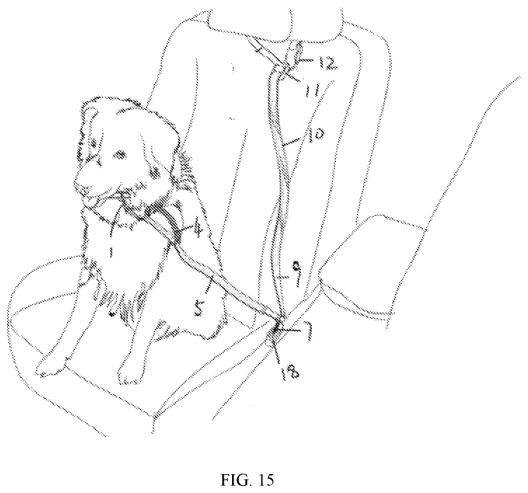

Please refer to FIG. 1 to FIG. 15, a novel non-slip adjustable multifunctional pet traction rope includes a movable ring snap hook 1, a first webbing 3, a parachute rope woven handle 4, a first webbing elastic part 5, and a second webbing 9 and a pulling handle 14. The movable ring snap hook 1, a first D-ring 2 and the parachute rope woven handle 4 are fixedly sewn on the first webbing 3 in sequence, the other end of the first webbing 3 is fixedly sewn with one end of the first webbing elastic part 5, and the other end of the first webbing elastic part 5 is fixedly sewn with a male buckle of automobile safety buckle 7 that can be connected with a female buckle of automobile safety buckle 18 for fixing, and is connected to one end of the second webbing 9 through a square ring 8. The first webbing elastic part 5 is movable sleeved with a fixing square buckle 6, the second webbing 9 is movable sleeved with an adjustable hook 11, an insertion buckle 12 and a second D-ring 13. The insertion buckle 12 is composed of a male buckle and a female buckle, one of the male buckle and the female buckle is sleeved on the second webbing 9, the other is fixedly sewn at one end of the second webbing 9, and the male buckle and the female buckle are fixedly buckled, so that one end of the second webbing 9 forms a pulling handle. The second D-ring 13 is located between the male buckle and the female buckle, that is, located on the pulling handle 14, and the adjustable hook 11 is located outside the male buckle and the female buckle.

The first webbing 3 is a reflective webbing, the first webbing elastic part 5 is a reflective elastic webbing, and the second webbing 9 is a rubber-coated webbing. Reflective patterns 10 are printed on both sides of the second webbing 9. A dog poop bag 15 can be carried on the first D-ring 2 or the second D-ring 13. The first D-ring 2 and the second D-ring 13 may be made of metal material, or is an elastic D-ring made of elastic rubber/silicone/latex. The insertion buckle 12 is a common buckle or an illuminated buckle. The pulling handle 14 can provide with a waist bag or an accessory bag 20.

Specifically, the function of the movable ring snap hook 1 is to connect the collar to tract the dog. The function of the parachute rope woven handle 4 is to prevent slipping in short distance when controlling the dog and The parachute rope woven handle 4 can be stored with accessories. The fixing square buckle 6 helps to realize fixing and storage of the male buckle of automobile safety buckle 7, the male buckle of automobile safety buckle 7 can realize mounting the dog in car. The webbing has a reflective function. The illuminated buckle can realize the light flashing function. The second D-ring 13 on the webbing is a rubber elastic material and can be installed and disassembled freely, and the D-ring can be used to hang the dog poop bag 15, keys and other objects, and can also achieve other functions.

The adjustable hook 11 cooperates with the insertion buckle 12 to fix the pulling handle 14 to make full use of the principle of multi-section friction and slip prevention of the webbing. The same webbing goes from bottom to top, the side passes from the bottom of the adjustable hook 11 to half part of the insertion buckle 12 (male buckle/female buckle) in an M shape, wherein two ends of the webbing that passes through the half part (male buckle/female buckle) of the insertion buckle are fixed by the adjustable hook, and then the entire structure of the webbing can be fixed by pulling the ends of the webbing for the buckle position. Applying backward force to the adjustable hook 11 with the bottom of the insertion buckle 12 as the fulcrum, and then the adjustable hook 11 is rotated by 90° to disengage the webbing fixed at both ends of the buckle from the hook opening, so that the fixing is released and the insertion buckle 12 and the adjustable hook 11 can realize free sliding. Both common webbing and rubber-coated webbing can be used for the fixing structure. Through the quick-release function and wide-range adjustment of the handle part, the pets can be controlled fixed at trees, guardrail, handrails, street light poles, power poles, waists, arms and other objects. It can be fixed on the waist to mount various small bags or waist bags for use. The parachute rope woven handle 4 can be used as a handle when the pulling handle 14 is adjusted to correspond to the size of the pet's neck and used as a collar. After the forward and backward transposition, it can still be used with the dog poop bag to realize the basic functions of pet traction rope and collar.

The embodiments of the present disclosure are not limited to this. According to the content of the above embodiments of the present disclosure, using the common knowledge and conventional means in the art, without departing from the basic technical ideas of the present disclosure, the above preferred embodiments can also be implemented in other forms of modification, replacement, or combination, and other obtained embodiments are within the scope of the present disclosure.

What is claimed is:

1. A novel non-slip adjustable multifunctional pet traction rope, comprising a movable ring snap hook (1), a first webbing (3), a parachute rope woven handle (4), a first webbing elastic part (5), and a second webbing (9) and a pulling handle (14); wherein the movable ring snap hook (1), a first D-ring (2) and the parachute rope woven handle (4) are fixedly sewn on the first webbing (3) in sequence, the other end of the first webbing (3) is fixedly sewn with one end of the first webbing elastic part (5), the other end of the first webbing elastic part (5) is fixedly sewn with a male buckle of automobile safety buckle (7) that is used to connected with a female buckle of automobile safety buckle (18) for fixing and the other end of the first webbing elastic part (5) is connected to one end of the second webbing (9) through a square ring (8); the first webbing elastic part (5) is movable sleeved with a fixing square buckle (6), the second webbing (9) is movable sleeved with a adjustable hook (11), an insertion buckle (12) and a second D-ring (13); the insertion buckle (12) is composed of a male buckle and a female buckle, one of the male buckle and the female buckle is sleeved on the second webbing (9), the other is fixedly sewn at one end of the second webbing (9), and the male buckle and the female buckle of the insertion buckle (12) are fixedly buckled, so that one end of the second webbing (9) forms a pulling handle (14); the second D-ring (13) is located between the male buckle and the female buckle of the insertion buckle (12), that is, the second D-ring (13) is located on the pulling handle (14), and the adjustable hook (11) is located outside the male buckle and the female buckle of the insertion buckle (12).

2. The novel non-slip adjustable multifunctional pet traction rope according to claim 1, wherein the first webbing (3) is a reflective webbing, the first webbing elastic part (5) is a reflective elastic webbing, the second webbing (9) is a rubber-coated webbing, and reflective patterns (10) are printed on both sides of the second webbing (9).

3. The novel non-slip adjustable multifunctional pet traction rope according to claim 1, wherein a dog poop bag is carried on the first D-ring (2) or the second D-ring (13); the first D-ring (2) and the second D-ring (13) are made of metal material or are elastic D-rings made of elastic rubber/silicone/latex.

4. The novel non-slip adjustable multifunctional pet traction rope according to claim 1, wherein the insertion buckle (12) is a common buckle or an illuminated buckle.

5. The novel non-slip adjustable multifunctional pet traction rope according to claim 1, wherein the pulling handle (14) is provided with a waist bag or an accessory bag (20).

6. The novel non-slip adjustable multifunctional pet traction rope according to claim 1, wherein the pulling handle (14) is configured to use as a collar after being adjusted by the insertion buckle (12), the parachute rope woven handle (4) is configured to use as a handle, and the parachute rope woven handle (4) is able to store with accessories.

7. The novel non-slip adjustable multifunctional pet traction rope according to claim 1, wherein the pulling handle (14) is able to realize quick release and wide-range adjustment functions after being adjusted by the insertion buckle (12), and pets can be controlled fixed at tree, guardrail, handle, street light pole, telegraph pole, waist, arm or other objects to realize a quick fixing and quick release.

8. The novel non-slip adjustable multifunctional pet traction rope according to claim 1, wherein the fixing square buckle (6) slides back and forth on the first webbing elastic part (5) to realize the fixing and storage of the male buckle of automobile safety buckle (7), the male buckle of automobile safety buckle (7) is configured to insert into the female buckle of automobile safety buckle (18) to achieve mounting a pet in car.

9. The novel non-slip adjustable multifunctional pet traction rope according to claim 1, wherein the first webbing (3) or the first webbing elastic part (5) or the second webbing (9) has a stitching position as square or rectangular diagonal cross stitching, plus M/W continuous cross stitching, to ensure solid and reliable use.

10. The novel non-slip adjustable multifunctional pet traction rope according to claim 1, wherein the second webbing (9) passes through the adjustable hook (11) and the insertion buckle (12) in an M shape to achieve fixing half portion of the insertion buckle (12), so as to quickly realize a series of operating steps such as non-slip, quick release, arbitrary range adjustment and fixing, and the other half of the insertion buckle (12) is enclosed to form a fixed second webbing (9) loop, a size of the second webbing (9) loop is limited by a length of the webbing, and the size of the second webbing loop is freely adjusted on the second webbing (9) with a fixed length.
